(19) United States
(12) Patent Application Publication
(10) Pub. No.: US 2016/0239305 A1
(43) Pub. Date: Aug. 18, 2016

(54) BRANCH TARGET BUFFER COLUMN PREDICTOR

(71) Applicant: International Business Machines Corporation, Armonk, NY (US)

(72) Inventors: James J. Bonanno, Wappingers Falls, NY (US); Brian W. Curran, Saugerties, NY (US); Daniel B. Lipetz, Linden, NJ (US); Brian R. Prasky, Campbell Hall, NY (US); Anthony Saporito, Highland, NY (US)

(21) Appl. No.: 15/089,928

(22) Filed: Apr. 4, 2016

Related U.S. Application Data
(63) Continuation of application No. 14/620,960, filed on Feb. 12, 2015.

(51) Int. Cl. G06F 9/38; G06F 9/30

(52) U.S. Cl. CPC G06F 9/3806; G06F 9/30058

(57) ABSTRACT

A processor receives a first instruction with a first instruction address within a first instruction stream. The processor selects a row of a branch target buffer and a row of a one-dimensional array based on the first instruction address. The processor reads information in the current row of the one-dimensional array, where the current row of one-dimensional array includes a first target address and a column of the row of the branch target buffer expected to contain a second target address. The processor receives a second instruction within a second instruction stream, which includes a second instruction address equal to the first target address. The processor reads information included in the row of the branch target buffer, where the information included the row of the branch target buffer includes the second target address. The processor encounters a branch including a third target address within the first instruction stream.

### BACKGROUND OF THE INVENTION

The present invention relates generally to the field of microprocessor design and more particularly to branch prediction.

Traditionally, branch prediction is used to steer the flow of instructions down a processor pipeline along the most likely path of code to be executed within a program. Branch prediction uses historical information to predict whether or not a given branch will be taken or not taken, such as predicting which portion of code included in an IF-THEN-ELSE structure will be executed based on which portion of code was executed in the past. The branch that is expected to be the first taken branch is then fetched and speculatively executed. If it is later determined that the prediction was wrong, then the speculatively executed or partially executed instructions are discarded and the pipeline starts over with the instruction proceeding the branch with the correct branch path, incurring a delay between the branch and the next instruction to be executed.

### SUMMARY

Embodiments of the invention disclose a method, computer program product, and computer system for predicting a branch in an instruction stream. A processor receives a first instruction within a first instruction stream, where the first instruction includes at least a first instruction address. The processor selects a current row of a branch target buffer and a corresponding current row of a one-dimensional array based, at least in part, on the first instruction address. The processor reads information included in the current row of the one-dimensional array, where the current row of one-dimensional array includes at least a first target address of a first prediction and a column of the current row of the branch target buffer expected to contain a second target address of a second prediction. The processor receives a second instruction within a second instruction stream, where the second instruction includes a second instruction address and the second instruction address is equal to the first target address. The processor reads information included in the current row of the branch target buffer, where the information included in at least one column of the current row of the branch target buffer includes at least the second target address of the second prediction. The processor encounters a branch present within the first instruction stream, where the encountered branch includes at least a third target address.

### BRIEF DESCRIPTION OF THE DRAWINGS

FIG. 1 is a block diagram of components of the computing device including the branch target buffer column predictor and branch target buffer, in accordance with an embodiment of the present invention.

FIG. 2 is a flowchart depicting operational steps required to use the branch target buffer column predictor, on a computing device within the data processing environment of FIG. 1, for predicting the presence, column, and target location of a branch indicated by a row in a branch target buffer, in accordance with an embodiment of the present invention;

FIG. 3 is a block diagram depicting the structure of the branch target buffer and branch target buffer column predictor of FIG. 1, for predicting the presence, and target location of a branch, in accordance with an embodiment of the present invention;

FIG. 4 is a flowchart depicting the operational steps required for using the branch target buffer column predictor of FIG. 1 in conjunction with the branch target buffer of FIG. 1, in accordance with an embodiment of the present invention.

FIG. 5 is a timing diagram illustrating the progression of successive branch prediction searches performed using the information stored in BTB 310, in accordance with an embodiment of the invention.

FIG. 6 is a timing diagram illustrating the progression of successive branch prediction searches performed using the information stored in BTB 310 and CPRED 320, in accordance with an embodiment of the invention.

### DETAILED DESCRIPTION

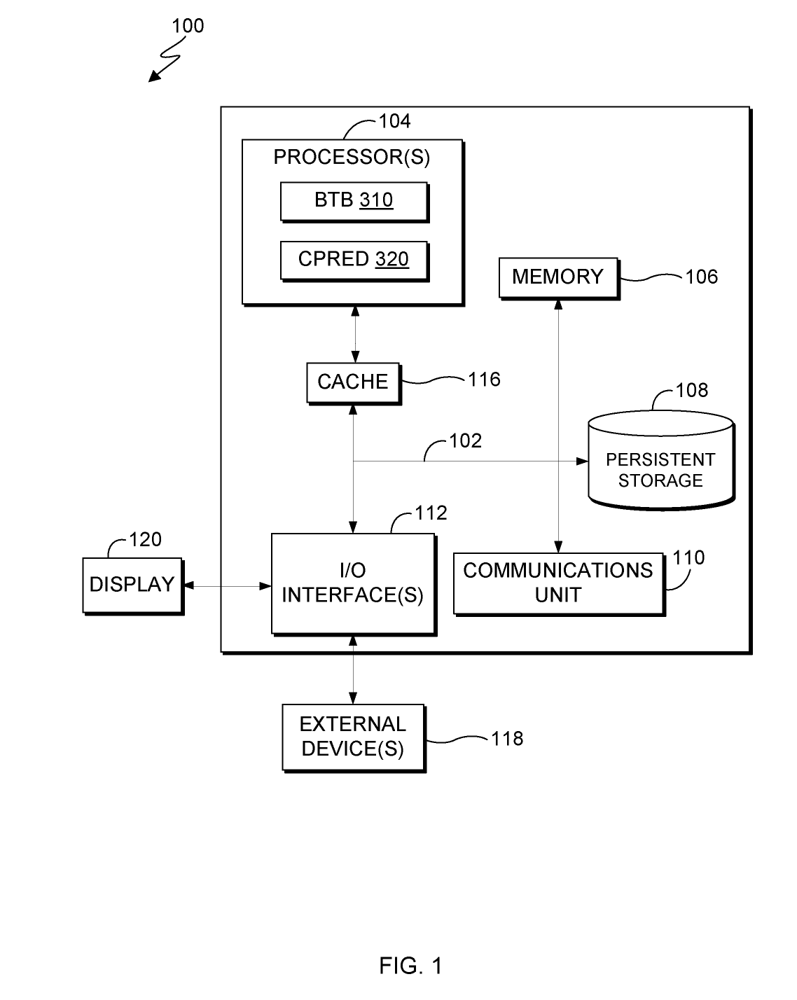

The present invention will now be described in detail with reference to the Figures. FIG. 1 is a functional block diagram illustrating a computer system, generally designated 100, in accordance with one embodiment of the present invention.

In general, embodiments of the present invention provide a branch target buffer column predictor (CPRED) used to predict the presence, column, and target of a branch indicated by a given row of a branch target buffer, and an approach to predict the presence and target of a branch using a branch target buffer column predictor.

FIG. 1 depicts computer system 100, which is an example of a system that includes the branch target buffer column predictor of embodiments of the present invention. Computer system 100 includes communications fabric 102, which provides communications between computer processor(s) 104, memory 106, persistent storage 108, communications unit 110, input/output (I/O) interface(s) 112, cache 116, branch target buffer (BTB) 310, and branch target buffer column predictor (CPRED) 320. Communications fabric 102 can be implemented with any architecture designed for passing data and/or control information between processors (such as microprocessors, communications and network processors, etc.), system memory, peripheral devices, and any other hardware components within a system. For example, communications fabric 102 can be implemented with one or more buses.

Memory 106 and persistent storage 108 are computer readable storage media. In this embodiment, memory 106 includes random access memory (RAM). In general, memory 106 can include any suitable volatile or non-volatile computer readable storage media. Cache 116 is a fast memory that enhances the performance of processors 104 by holding recently accessed data and data near accessed data from memory 106.

Program instructions and data used to practice embodiments of the present invention may be stored in persistent storage 108 for execution by one or more of the respective processors 104 via cache 116 and one or more memories of memory 106. In an embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 108 may also be removable. For example, a removable hard drive may be used for persistent storage 108. Other examples include optical and magnetic disks, thumb drives, and smart cards that are inserted into a drive for transfer onto another computer readable storage medium that is also part of persistent storage 108.

Communications unit 110, in these examples, provides for communications with other data processing systems or devices. In these examples, communications unit 110 includes one or more network interface cards. Communications unit 110 may provide communications through the use of either or both physical and wireless communications links. Program instructions and data used to practice embodiments of the present invention may be downloaded to persistent storage 108 through communications unit 110.

I/O interface(s) 112 allows for input and output of data with other devices that may be connected to each computer system. For example, I/O interface 112 may provide a connection to external devices 118 such as a keyboard, keypad, a touch screen, and/or some other suitable input device. External devices 118 can also include portable computer readable storage media such as, for example, thumb drives, portable optical or magnetic disks, and memory cards. Software and data used to practice embodiments of the present invention can be stored on such portable computer readable storage media and can be loaded onto persistent storage 108 via I/O interface(s) 112. I/O interface(s) 112 also connect to a display 120.

Display 120 provides a mechanism to display data to a user and may be, for example, a computer monitor.

Processor(s) 104 include BTB 310 and CPRED 320 which are sets of hardware logic components capable of storing predictions for the location of branches in an instruction stream.

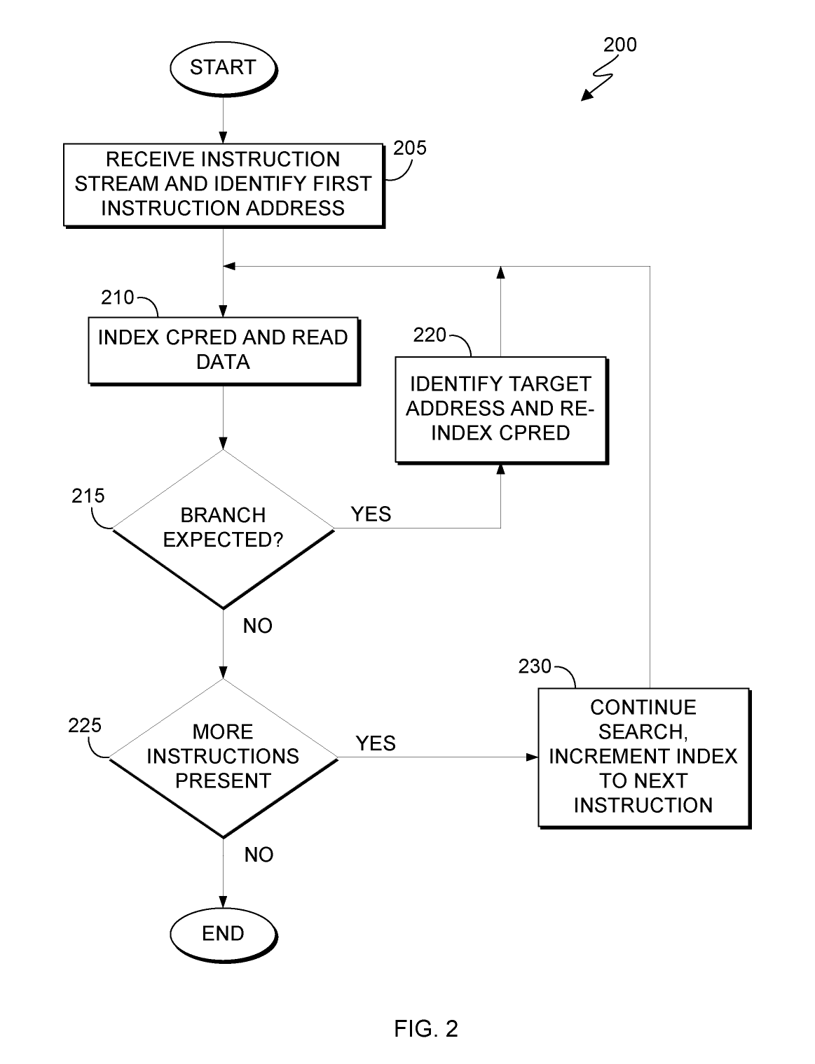

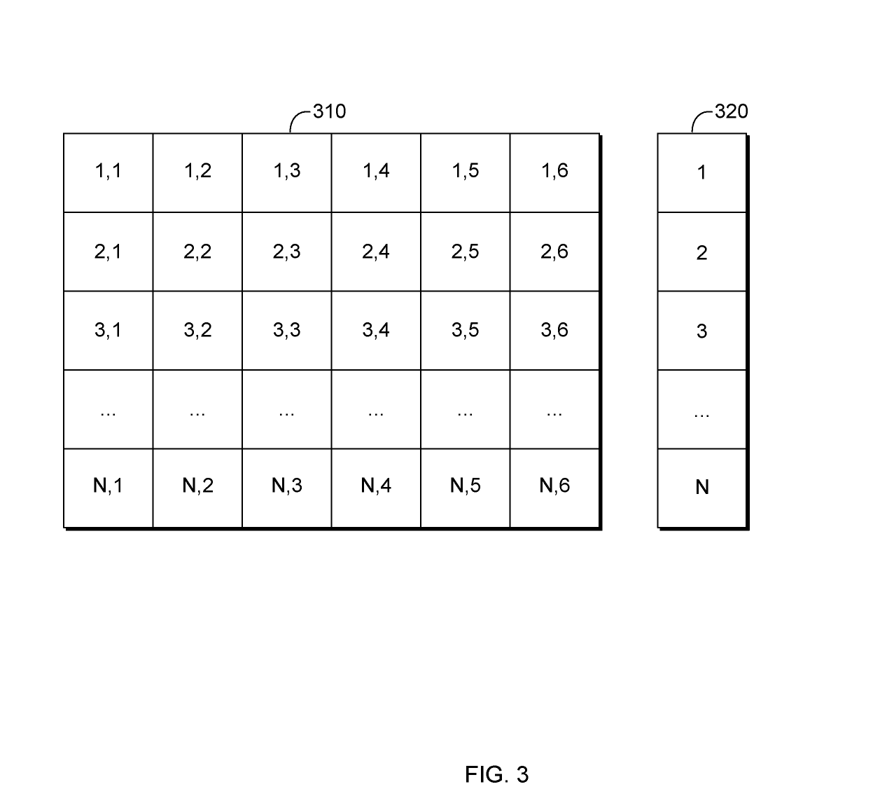

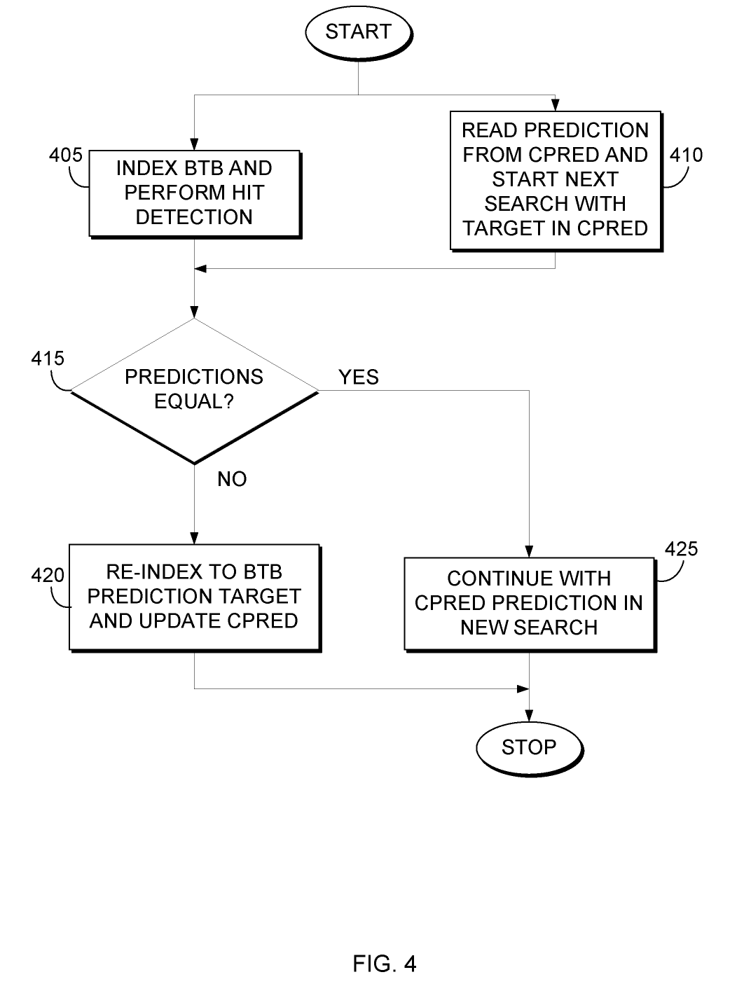

FIG. 2 is a flowchart, generally depicted 200, depicting the operational steps used in the utilization of the branch target buffer column predictor of the invention (CPRED 320), in accordance with an embodiment of the invention. It should be appreciated that the process described in FIG. 2 describes the operation of CPRED 320 in embodiments where the predictions drawn from CPRED 320 are verified by the predictions later drawn from BTB 310. In other embodiments where the predictions drawn from CPRED 320 differ from the predictions drawn from BTB 310, the information stored in CPRED 320 is updated using the process described in greater detail with respect to FIG. 4. The structure and usage of CPRED 320 and BTB 310 are described in greater detail with respect to FIG. 3.

In step 205, a microprocessor such as processor(s) 104 receives a stream of instructions describing one or more operations which the microprocessor is to perform, and identifies the address of the first instruction present in the instruction stream. In some embodiments, one or more branches may be present in the instruction stream at various locations. In general, a branch represents a possible break in the sequential instruction stream which describes a new location within the instruction stream where processing is to jump to. In some embodiments, two-way branching is implemented within a high level programming language with a conditional jump instruction such as an if-then-else structure. In these embodiments, a conditional jump can either be “not taken” and continue execution with the set of instructions which follow immediately after the conditional jump in the instruction stream, or it can be a “taken” branch and jump to a different place in instruction stream where the second branch of instructions are stored. In general, a branch such as a two-way branch is predicted using information stored in BTB 310 and CPRED 320 to be either a “taken” branch or a “not taken” branch before the instruction or set of instructions containing the branch is executed by the microprocessor. It should be appreciated by one skilled in the art that instructions will be structured differently in various embodiments of the invention where different architectures and instruction sets are used by microprocessors such as processor(s) 104.

In step 210, CPRED 320 is indexed to the row corresponding to the address of the first instruction received in the instruction stream and the information included in the current row of CPRED 320 is read. In various embodiments, depending on the width of the address space, various numbers of unique instruction addresses may be present, and as a result different numbers of rows may be required for CPRED 320 in various embodiments of the invention. Generally, only a subset of bits of the instruction address for a given instruction are used to identify the row number in CPRED 320 which contains branch prediction data for the given instruction. For example, in an embodiment where 32-bit instruction addresses are used (including bits 0 through 31), each instruction address is split into an L-tag made up of the first 17 bits of the instruction address (bits 0 through 16), an index made up of the next 10 bits of the instruction address (bits 17 through 26), and an R-tag made up of the final 5 bits of the instruction address (bits 27 through 31). In this embodiment, because only the ten bits of the instruction address used as the index are used to determine the row in CPRED 320 in which the branch prediction data is stored for that instruction, CPRED 320 includes 1024 (2¹⁰) rows. Further, in some embodiments CPRED 320 is designed to contain the same number of rows as BTB 310 and be indexed based on the same 10 bits of the instruction address as BTB 310. In other embodiments, BTB 310 and CPRED 320 use different numbers of bits to determine which row in the respective tables contain the branch prediction information for that instruction. In these embodiments, it is possible for BTB 310 and CPRED 320 to have different numbers of rows while still allowing for the invention to operate correctly.

In decision step 215, the data contained in the row of CPRED 320 corresponding to the current instruction is read to determine if a branch is expected for the current instruction. It should be appreciated that one row of CPRED 320 can correspond to a large number of instruction addresses in embodiments where aliasing is used, and that in these embodiments multiple instruction addresses will correspond to the same row in CPRED 320. In one embodiment, the first bit of data stored in the current row of CPRED 230 contains a binary indication of whether or not a taken prediction is present in the corresponding row of BTB 310. In this embodiment, the determination of whether or not a taken prediction is present in the corresponding row of BTB 310 is made using this single bit of data alone. In this embodiment, if the first bit of data is a zero indicating that there is not taken prediction present in the corresponding row of BTB 310 (decision step 215, no branch), then processor(s) 104 determines if more instructions are present in the instruction stream in decision step 225. If the first bit of data is a one indicating that there is a taken prediction present in the corresponding row of BTB 310 (decision step 215, yes branch), then processor(s) 104 identifies the target address of the first taken branch indicated by the current row of CPRED 320 in step 220.

In step 220, processor(s) 104 identifies the target address of the first taken branch prediction indicated in the current row of CPRED 320. In one embodiment, a single 17-bit binary number is contained in each row of CPRED 320. In this embodiment, the first bit of data present in a row “K” of CPRED 320 is a binary indicator which indicates whether or not a valid prediction for a taken branch is expected to be present in any of the columns present in row “K” of BTB 310. In this embodiment, because there are six columns present in BTB 310, six bits of additional data are used to indicate whether the first taken prediction is present in each of the six columns present in the row “K” of BTB 310. In general, the “n^{th}” digit of these six digits indicates that the “n^{th}” column of row “K” of BTB 310 will contain the first taken branch prediction. It should be appreciated that only one of the “n” digits can have a value of one at a given time. In this embodiment, the final 10 bits of data are used to store a portion of the predicted target address of the first taken branch predicted to be stored in the row “K” of BTB 310. It should be appreciated that the number of bits of the target address stored in each row of CPRED 320 varies in different embodiments of the invention. In some embodiments, an additional structure such as a changing target buffer (CTB) may be used to predict the target address for the first taken prediction indicated by one or more rows of CPRED 320. In these embodiments, the target address of the first taken prediction may be omitted, and the indication of the column of row “K” of BTB 310 is used to more easily identify the target address of the first taken prediction using the additional structure such as the CTB. In general, the indication of which column of row “K” of BTB 310 contains the first taken prediction is used in embodiments where additional structures such as a CTB are used, or embodiments where the first taken branch is a branch of a certain type such as MCENTRY, MCEND, EX, or EXRL.

It should be appreciated that a prediction is drawn from BTB 310 simultaneously while a prediction is drawn from CPRED 320, and that the re-indexing performed using the prediction drawn from CPRED 320 is valid until confirmed or disputed by the prediction drawn from BTB 310, as described in greater detail with respect to FIG. 4. Additionally, it should be appreciated that CPRED 320 does not provide a prediction of the full target address of the first taken branch, but predicts only a subset of the bits of the target address of the first taken branch. In general, the prediction of the full target address is retrieved from BTB 310 using the indication of the column of row “K” of BTB 310 expected to contain the first taken prediction included in CPRED 310. In the depicted embodiment, a prediction of a taken branch is drawn by examining the first bit of the 17-bit number included in the current row of CPRED 320 to determine if a valid prediction is present, and if a valid prediction is present, then examining the last 10 bits of the 17-bit number included in the current row of CPRED 320 to determine a portion of the target address of the predicted branch used to re-index BTB 310 and CPRED 320 to the rows corresponding to the target address of the predicted first taken branch. It should be appreciated that the last 10 bits of the 17-bit number included in the current row of CPRED 320 represent a subset of the bits of the target address of the predicted branch. In various embodiments, the bits of data included in CPRED 320 are the bits of data used to re-index CPRED 320 to the target address of the prediction. In embodiments where more or fewer bits of data are used to re-index CPRED 320, the length of the number included in a given row of CPRED 320 will differ from the 17 bits of data described in the current embodiment. Once the target address of the first taken branch prediction is identified, processor(s) 104 re-indexes CPRED 320 and BTB 310 to the rows corresponding to the target address for the first taken branch prediction. Once CPRED 320 and BTB 310 are re-indexed, processor(s) 104 re-starts the process of searching BTB 310 and CPRED 320 for branch predictions at the new target address in step 210.

In decision step 225, processor(s) 104 determines if more instructions are present in the instruction stream. In general, determining that more instructions are present is accomplished by receiving a request for a search restart from the main branch predictor using the next sequential instruction address. If no request for restarts is received (decision step 225, no branch), then branch prediction search ends. If a request for a restart is received with an instruction address following the previous instruction address (decision step 225, yes branch), then processor 104 continues searching the next sequential rows of BTB 310 and CPRED 320 for predictions of the presence of branches in step 230. In the depicted embodiment, step 230 includes incrementing the index of the current rows of BTB 310 and CPRED 320 and starting a new search by reading the data included in the new current rows of BTB 310 and CPRED 320. In general, the indexes of BTB 310 and CPRED 320 are incremented because the next row in BTB 310 and CPRED 320 contains branch prediction information for the next sequential set of instructions present in the instruction stream.

FIG. 3 is a block diagram of the components of branch target buffer (BTB) 310 and branch target buffer column predictor (CPRED) 320, in accordance with an embodiment of the invention.

BTB 310 is a collection of tabulated data including “M” columns and “N” rows of data. In the depicted embodiment, the value of “M” is depicted as being 6, yielding an embodiment where BTB 310 contains a total of six columns used to store the six most recent predictions for each row present in BTB 310. In general, a given cell in BTB 310 is referred to as BTB(N, M), where “N” is the row number and “M” is the column number. It should be appreciated that the number of rows and columns included in BTB 310 varies in different embodiments of the invention and that the depicted embodiment of BTB 310 which included 6 columns and 1024 rows is not meant to be limiting. It should be appreciated by one skilled in the art that various methods for drawing predictions from the information included in BTB 310 may be used in various embodiments of the invention, and that the invention is not limited to any specific method of drawing predictions from the information included in BTB 310. Additionally, the information included in BTB 310 may be stored or encoded differently in various embodiments of the invention, and the examples provided of how information is stored in BTB 310 is not meant to be limiting.

CPRED 320 is a one-dimensional array of data used in conjunction with BTB 310 by branch prediction logic to predict the column in which the first taken prediction will be present in BTB 310 for a given row. In some embodiments, CPRED 320 contains the same number of rows (“N”) as BTB 310, with a given row “K” in CPRED 320 providing information related to the first taken prediction present in the corresponding row “K” of BTB 310. In other embodiments, CPRED 320 contains fewer rows than BTB 310, and in these embodiments aliasing is used to apply the column prediction contained in row “K” of CPRED 320 to multiple rows in BTB 310. In general, decreasing the size of CPRED 320 is desirable in embodiments where reducing the amount of time required to access CPRED 320 or limiting memory required by CPRED 320 is important. Additionally, increasing the size of CPRED 320 is desirable in embodiments where reducing the amount of time required to access CPRED 320 or limiting memory required by CPRED 320 is not important, and improving the accuracy of each branch prediction is important. For example, in an embodiment where the address space has a dimension of three bits, BTB 310 contains eight rows of data to ensure that each possible address corresponds to a unique row in BTB 310 which can be used to predict the presence of branches in the instruction stream for that address. In this example, it is possible to use only two rows of data for CPRED 320 and utilize the prediction contained in each row of CPRED 320 for four rows of BTB 310. For example, if BTB 310 includes rows numbered 1 through 8, then row 1 of CPRED 320 is used to provide a column prediction for rows 1 through 4 of BTB 310 while row 2 of CPRED 320 is used to provide a column prediction for rows 5 through 8 of BTB 310.

In general, the data included in each row of CPRED 320 describes which column in BTB 310 contains the last taken prediction for the corresponding row in BTB 310. In some embodiments, the address of the first taken branch target for a row “K” in BTB 310 is included in the entry for the corresponding row “K” in CPRED 320. The reason for including the address of the first taken branch target is to be able to re-index BTB 310 and CPRED 320 to the address of the first taken branch target without having to retrieve the address of the first taken branch target from BTB 310.

In various embodiments, BTB 310 and CPRED 320 are accessed simultaneously, and a prediction is drawn from both BTB 310 and CPRED 320 independently. It should be appreciated by one skilled in the art that in these embodiments, many different methods for drawing predictions from BTB 310 may be used. Because of the decreased number of cycles required to draw a prediction from CPRED 320, the prediction drawn from CPRED 320 is used as a preliminary prediction until confirmed by the prediction drawn from BTB 310. In embodiments where the prediction drawn from BTB 310 is the same as the prediction drawn from CPRED 320, branch prediction logic proceeds to continue retrieving additional predictions for the following instructions in the instruction stream. In embodiments where the prediction drawn from CPRED 320 differs from the prediction later drawn from BTB 310, the prediction drawn from BTB 310 is assumed to be more reliable and as a result BTB 310 and CPRED 320 are both re-indexed to the address of the first taken branch target predicted by BTB 310 and the column prediction data and address of the new first taken branch target are updated for the corresponding row “K” in CPRED 320.

FIG. 4 is a flowchart depicting the operational steps required to utilize BTB 310 and CPRED 320 in conjunction with each other to draw branch predictions and update the predictions stored in CPRED 320 in the event that an incorrect prediction is present.

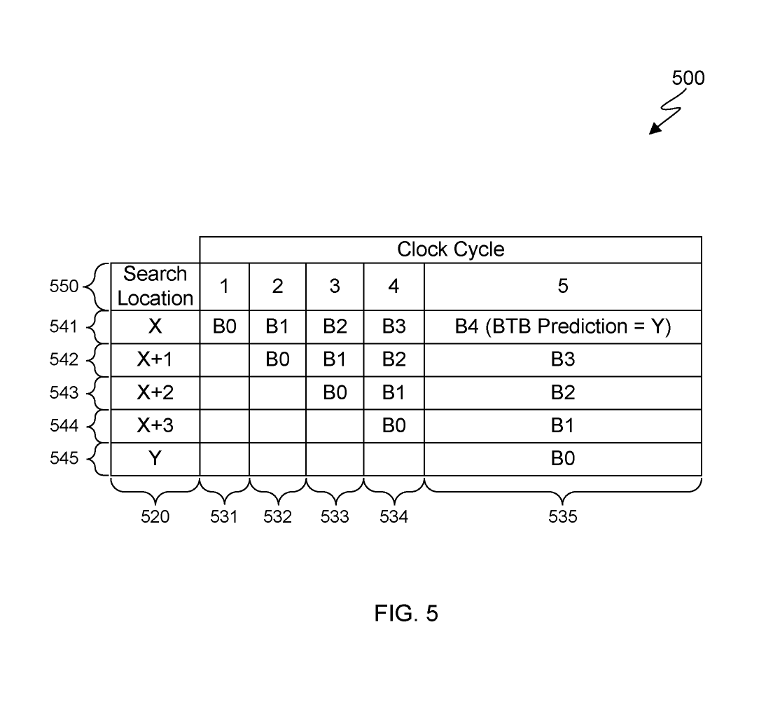

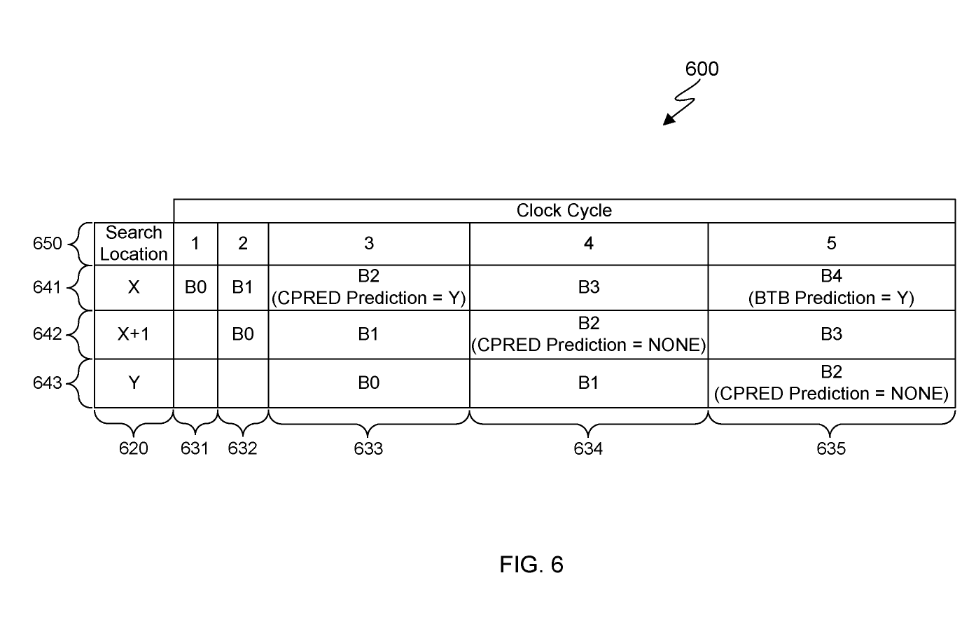

In step 405, BTB 310 is indexed to a row “K” corresponding to the current instruction, and hit detection is performed on the row “K” to determine which column (if any) contains a usable branch prediction for that instruction. In general, it takes five clock cycles for a branch prediction to be reported using the information stored in BTB 310, and after the first prediction is reported, additional prediction are reported once every four cycles. As a result of this, predictions drawn using the information stored in BTB 310 alone can be issued every four clock cycles. In this embodiment, due to predictions from CPRED 320 being drawn faster (once every two clock cycles once the first prediction is reported), BTB 310 and CPRED 320 are both re-indexed once predictions are drawn from CPRED 320 every second clock cycle, and the predictions drawn from BTB 310 alone are used to verify the predictions drawn from CPRED 320 two clock cycles earlier. The cycles required for drawing predictions from the information included in BTB 310 and CPRED 320 are described in greater detail with respect to FIGS. 5 and 6.

In step 410, CPRED 320 is indexed to a row “K” corresponding to the current instruction and the prediction contained in the row “K” of CPRED 320 is read. The prediction read from row “K” of CPRED 320 is used to start a new search using the partial target address read from row “K” of CPRED 320. In the depicted embodiment, steps 405 and 410 begin simultaneously and occur in parallel when a new instruction is received by processor(s) 104. In general, it takes three clock cycles for a prediction to be reported from the data included in CPRED 320. In clock cycle 0, CPRED 320 is indexed to the row “K” corresponding to the current instruction. In clock cycle 1, the information stored in the row “K” of CPRED 320 is read by processor(s) 104, along with information describing which columns in BTB 310 is expected to contain the first taken branch. In clock cycle 2, the prediction of the first taken branch is reported and both BTB 310 and CPRED 320 are re-indexed to the address of the first taken branch predicted by the information in row “K” of CPRED 320. Both BTB 310 and CPRED 320 are re-indexed at this time to ensure that the branch prediction search for the next target location occurs as soon as possible. It should be appreciated that clock cycle 2 serves as clock cycle 0 for the following branch prediction search performed using the information stored in CPRED 320.

In decision step 415, the prediction reported in step 410 is compared to the prediction reported in step 405 to determine if CPRED 320 predicted the location and target of the first taken branch present in BTB 310 correctly for the given branch. In one embodiment, the target addresses included in both branch predictions are compared to determine if there is any difference between the prediction reported in step 410 and the prediction reported in step 405. In various embodiments, the prediction drawn from the data included in CPRED 320 includes only a subset of the bits of the target address of the prediction drawn from the information included in BTB 310. In these embodiments, only the bits which are included in both predictions are compared. If the predictions are equal (decision step 415, yes branch), then processor(s) 104 continues with the branch prediction search initiated in step 410 using the data received from CPRED 320 in step 425. If the predictions received are not equal (decision step 415, no branch), then processor(s) 104 re-indexes CPRED 320 and BTB 310 to the first taken branch prediction reported in step 405, and starts the branch prediction search over from that point.

In step 420, BTB 310 and CPRED 320 are re-indexed to the address of the first taken branch predicted in step 405. Additionally, the information stored in the row “K” of CPRED 320 is updated to reflect the prediction reported in step 405. In this process, the correct address of the branch target predicted in step 405 is written to row “K” of CPRED 320 along with the column of BTB 310 from which the prediction reported in step 405 was fetched.

In step 425, the search initiated in step 410 continues based on the prediction drawn from the information included in row “K” of CPRED 320. It should be appreciated that the process of continuing the search started in step 410 includes re-indexing CPRED 320 to the row corresponding to the target address of each new branch prediction as they are encountered. For example, in the depicted embodiment, a branch prediction included in row “K” of CPRED 320 includes a target address corresponding to row “L” of CPRED 320. After re-indexing CPRED 320 to row “L”, a prediction with a target address corresponding to row “M” is read. In general, the process of identifying successive predictions is referred to as continuing a search.

FIG. 5 is a timing diagram, generally designated 500, illustrating successive branch prediction searches performed using BTB 310. Each column of timing diagram 500 present below row 550, such as columns 531, 532, 533, 534, and 535 illustrates the current status of each branch prediction search currently being performed by processor 104 in a given clock cycle, with the clock cycle number indicated by the cell present within row 550 of that column. Each row of timing diagram 500 present below row 550, such as rows 541, 542, 543, 544, and 545 illustrates the current state of a branch prediction search performed by processor 104 using BTB 310 in successive clock cycles. For the search represented by a given row of timing diagram 500, the row of BTB 310 currently being searched is indicated by the cell within column 520 of that row. Row 550 indicates the current clock cycle of processor 104 performing the various branch prediction searches indicated by timing diagram 500.

Row 541 illustrates a branch prediction search with search address “X” which involves drawing a prediction using the information included in row “X” of BTB 310. In the depicted embodiment, the prediction is drawn from the information included in row “X” of BTB 310 in the fifth cycle of the branch prediction search (B4) (row 541, col 531). In the depicted embodiment, the five cycles required for each branch prediction search performed using BTB 310 are B0, B1, B2, B3, and B4. In cycle B0, BTB 310 is indexed to a starting search address of “X”. In some embodiments the starting search address has additional properties associated with it such as an indication of whether or not the instructions received by processor 104 are in millicode, the address mode, a thread associated with the instructions received by processor 104, or other information stored in BTB 310 in various embodiment of the invention. In general, cycle B1 is an access cycle for BTB 310 which serves as busy time while information included in row “X” of BTB 310 is retrieved. In cycle B2, the entries in row “X” are returned from BTB 310 and hit detection begins. In various embodiments, hit detection includes ordering the entries in row “X” by instruction address space, filtering for duplicate entries, filtering for a millicode branch if the search is not for a millicode instruction or set of millicode instructions, or filtering for other criteria indicated by the entries present in row “X” of BTB 310. In some embodiments, hit detection additionally includes discarding any branch with an address earlier than the starting search address and identifying the first entry that is predicted to be taken. Additionally, any entry for a taken branch present after the first taken branch in the instruction space may be discarded, and all of the remaining branch predictions including the first taken branch prediction and a number of not taken branch predictions are reported. In cycle B3, hit detection continues and concludes with an indication of whether or not any of the entries included in row “X” of BTB 310 contain a valid prediction of a branch which is expected to be encountered in the instruction stream. In cycle B4, the target address of the first taken prediction is reported and a new branch prediction search is initiated with a search address equivalent to the target address of the first taken prediction reported.

In the depicted embodiment, in clock cycle 1 a branch prediction search with a search address of “X” begins cycle B0 (row 541, col 531). In clock cycle 2, the branch prediction search with a search address of “X” advances to cycle B1 (row 541, col 532), while a new branch prediction search with a search address of “X+1” begins cycle B0 (row 542, col 532). It should be appreciated that the index “X+1” represents the next sequential portion of the address space present after “X”, and that correspondingly row “X+1” represents the next row present in BTB 310 present after row “X”. In clock cycle 3, the branch prediction search with a search address of “X” advances to cycle B2 (row 541, col 533), the branch prediction search with a search address of “X+1” advances to cycle B1 (row 542, col 533), and a new branch prediction search is initiated with a search address of “X+2” (row 543, col 533). In clock cycle 4, the branch prediction search with a search address of “X” advances to cycle B3 (row 541, col 534), the branch prediction search with a search address of “X+1” advances to cycle B2 (row 542, col 534), the branch prediction search with a search address of “X+2” advances to cycle B1 (row 543, col 534), and a new branch prediction search is initiated with a search address of “X+3” (row 544, col 534). In clock cycle 5, the branch prediction search with a search address of “X” advances to cycle B4 and issues a prediction of a first taken branch with a target address of “Y” (row 541, col 535). As illustrated in the depicted embodiment of the invention, a new branch prediction search is initiated in clock cycle 5 with a search address of “Y” (row 545, col 535). In some embodiments, the searches with search indices “X+1”, “X+2”, and “X+3” are cancelled upon the search with an index of “X” reporting a prediction for a taken branch. However, in the depicted embodiment, these searches continue to advance to the next cycles before being cancelled following clock cycle 5.

In general, it should be appreciated that, using BTB 310 alone, branch prediction logic can identify a taken prediction up to once every four clock cycles.

FIG. 6 is a timing diagram, generally designated 600, illustrating successive branch prediction searches performed using BTB 310 and CPRED 320. Similarly to FIG. 5, each column of timing diagram 600 present below row 650, such as columns 631, 632, 633, 634, and 635 illustrates the current status of each branch prediction search currently being performed by processor 104 in a given clock cycle, with the clock cycle number being indicated by the cell present within row 650 of that column. Each row of timing diagram 600 present below row 650, such as rows 641, 642, and 643 illustrates the current state of an individual branch prediction search performed by processor 104 using BTB 310 and CPRED 320 in each clock cycle. For the search represented by a given row of timing diagram 600, the row of BTB 310 and CPRED 320 currently being searched is indicated by the cell within column 620 of that row. Row 650 indicates the current clock cycle of processor 104 performing the various branch prediction searches indicated by timing diagram 600.

Row 641 illustrates a branch prediction search with search address “X” which involves drawing a prediction using the information included in row “X” of BTB 310 and row “X” of CPRED 320. It should be appreciated that in some embodiments, different indexing structures are used for BTB 310 and CPRED 320. In these embodiments, the row “X” of BTB 310 from which information is read will differ from the row of CPRED 320 from which information is read. It should additionally be appreciated that the embodiment where BTB 310 and CPRED 320 use the same indexing structure serves as an example of one embodiment and is not meant to be limiting. In the depicted embodiment, a prediction is drawn from the information included in row “X” of CPRED 320 in the third cycle of the branch prediction search (cycle B2), and a prediction is drawn from the information included in row “X” of BTB 310 in the fifth cycle of the branch prediction search (cycle B4). In the depicted embodiment, the five cycles required for each branch prediction search performed using information included in BTB 310 are the same five cycles B0 through B4 as described in greater detail with respect to FIG. 5. In this embodiment, the three cycles required to draw a prediction from the information included in row “X” of CPRED 320 are B0, B1, and B2. In cycle B0, CPRED 320 is indexed to a starting search address of “X”. In some embodiments the starting search address has additional properties associated with it such as an indication of whether or not the instructions received by processor 104 are in millicode, the address mode, a thread associated with the instructions received by processor 104, or other information stored in BTB 310 or CPRED 320 in various embodiments of the invention. In general, cycle B1 is an access cycle for CPRED 320 which serves as busy time while information included in row “X” of CPRED 320 is retrieved. In cycle B2, the target address of the first taken prediction is reported and a new branch prediction search is initiated with a search address equivalent to the target address of the first taken prediction reported.

In the depicted embodiment, in clock cycle 1 a branch prediction search with a search address of “X” begins cycle B0 (row 641, col 631). In clock cycle 2, the branch prediction search with a search address of “X” advances to cycle B1 (row 641, col 632), while a new branch prediction search with a search address of “X+1” begins cycle B0 (row 642, col 632). It should be appreciated that the index “X+1” represents the next sequential portion of the address space present after “X”, and that correspondingly row “X+1” represents the next row present in BTB 310 and CPRED 320 after row “X”. In clock cycle 3, the branch prediction search with a search address of “X” advances to cycle B2 and returns a prediction of a first taken branch with a target address of “Y” (row 641, col 633). As illustrated in the depicted embodiment of the invention, a new branch prediction search is initiated in clock cycle 3 with a search address of “Y” (row 643, col 633). In some embodiments, the search with search address “X+1” is cancelled upon the search with an index of “X” reporting a prediction for a taken branch. However, in the depicted embodiment, these searches continue without being cancelled. In clock cycle 4, the branch prediction search with a search address of “X” advances to cycle B3 (row 641, col 634), the branch prediction search with a search address of “X+1” advances to cycle B2 and returns a prediction of no taken branch (row 642, col 634), and the branch prediction search with a search address of “Y” advances to cycle B1 (row 643, col 634). In some embodiments, a new branch prediction search with a search address of “Y+1” may begin in clock cycle 4, however no additional searches are depicted in FIG. 6. In clock cycle 5, the branch prediction search with a search address of “X” advances to cycle B4 and reports a prediction of a first taken branch with a target address of “Y” (row 641, col 635) based on the information contained in BTB 310, confirming the prediction reported in clock cycle 3 using the information contained in CPRED 320. Additionally in clock cycle 5, the branch prediction search with a search address of “X+1” advances to cycle B3 (row 642, col 635) and the branch prediction search with a search address of “Y” advances to cycle B2 and reports a prediction of no taken branch (row 643, col 635). In embodiments where a branch is predicted in clock cycle 5, a new branch prediction search with a search address equal to the target address of the branch prediction in clock cycle 5 may begin in clock cycle 5, however no additional searches are depicted in FIG. 6.

In general, it should be appreciated that, using both BTB 310 and CPRED 320, branch prediction logic can identify a taken branch up to once every two clock cycles. Additionally, it should be appreciated that the use of CPRED 320 allows for predictions to be reported earlier and allows for the creation of a new search with a search address equivalent to the target address of a taken branch prediction in cycle B2 as opposed to cycle B4.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for predicting a branch in an instruction stream, the method comprising:
receiving, by a processor, a first instruction within a first instruction stream, wherein the first instruction includes at least a first instruction address;
selecting, by the processor, a current row of a branch target buffer and a corresponding current row of a one-dimensional array based, at least in part, on the first instruction address;
reading, by the processor, information included in the current row of the one-dimensional array, wherein the current row of one-dimensional array includes at least a first target address of a first prediction and a column of the current row of the branch target buffer expected to contain a second target address of a second prediction, wherein each prediction comprises an expected address, within the first instruction stream, of a taken branch and a target address of the taken branch;
receiving, by the processor, a second instruction within a second instruction stream, wherein the second instruction includes a second instruction address and the second instruction address is equal to the first target address, and wherein the second instruction stream comprises at least a portion of the first instruction stream;
reading, by the processor, information included in the current row of the branch target buffer, wherein the information included in at least one column of the current row of the branch target buffer includes at least the second target address of the second prediction;
determining, by the processor, that the first target address differs from the second target address based, at least in part, on the information read from the current row of the branch target buffer and the information read from the current row of the one-dimensional array;
updating, by the processor, the information included in the current row of the one-dimensional array to include the second target address of the second prediction and the at least one column of the current row of the branch target buffer that includes at least the second target address of the second prediction;
encountering, by the processor, a branch present within the first instruction stream, wherein the encountered branch includes at least a third target address;
determining, by the processor, that the first target address is equivalent to the second target address and differs from the third target address based, at least in part, on the information read from the current row of the one-dimensional array and the branch encountered within the first instruction stream;
updating, by the processor, the information included in the current row of the one-dimensional array to include the third target address;
determining, by the processor, that first target address is equivalent to the second target address and the third target address based, at least in part, on the information read from the current row of the one-dimensional array, the column of the current row of the branch target buffer containing the second prediction, and the branch encountered within the first instruction stream;
executing, by the processor, at least the second instruction and a third instruction present within the second instruction stream; and
removing, by the processor, the second instruction stream.
